(19) United States
(12) Patent Application Publication
(10) Pub. No.: US 2026/0042358 A1
(43) Pub. Date: Feb. 12, 2026

(54) BATTERY EFFICIENCY OPTIMIZATION METHOD IN DUAL BATTERY SYSTEM AND SYSTEM FOR THE SAME

(71) Applicants: Hyundai Motor Company, Seoul (KR); Kia Corporation, Seoul (KR)

(72) Inventors: Min Su Kim, Hwaseong-si (KR); Dae Won Yang, Hwaseong-si (KR)

(21) Appl. No.: 19/173,213

(22) Filed: Apr. 8, 2025

(30) Foreign Application Priority Data
Aug. 7, 2024 (KR) 10-2024-0105438

(51) Int. Cl. B60L 50/60; B60L 58/12; B60L 58/20

(52) U.S. Cl. CPC B60L 50/60; B60L 58/12; B60L 58/20; B60L 2210/40; B60L 2240/527

(57) ABSTRACT

A method performed by a dual battery system for supplying power to a motor is introduced. The method comprises monitoring state information of a main battery and a sub battery of the dual battery system, determining a demand power for the motor, and selecting at least two amplification power candidate values for the sub battery based on the state information of the main battery, the state information of the sub battery, and the demand power. The method further comprises determining a discharge loss rate for each amplification power candidate value.

This application claims the benefit of priority to Korean Patent Application No. 10-2024-0105438 filed in the Korean Intellectual Property Office on Aug. 7, 2024, the entire contents of which are hereby incorporated by reference.

### TECHNICAL FIELD

The present disclosure relates to a battery efficiency optimization method in a dual battery system and a system for the same and, more particularly, to a method that determines an on-drive charge (ODC) discharge power by comparing an available ODC discharge power in an ODC-equipped dual battery system and a vehicle driving power and determining a discharge loss rate, thereby enabling system optimization based on efficiency comparison in the entire area under the ODC control and improving the power ratio during ODC-based driving in a high-speed driving area on a real road.

### BACKGROUND

The matters described in this Background section are only for the enhancement of understanding of the background of the disclosure, and should not be taken as acknowledgment that they correspond to prior art already known to those skilled in the art.

An electrical system of an electric vehicle (EV) or a plug-in hybrid electric vehicle (PHEV)is gaining attention amid the trend of increasing environmental concern worldwide

The EV may be an electric vehicle capable of traveling, for example, more than 400 kilometers (km) after a single full charge of a main high-voltage battery, which may partially satisfy some needs of consumers

To address additional consumer needs, a dual battery system is considered. For example, the dual battery system may comprise a main high-voltage battery and a sub high-voltage battery that is different from the main high-voltage battery (e.g., different capacity).

### SUMMARY OF THE PRESENT DISCLOSURE

According to the present disclosure, a method performed by a dual battery system for supplying power to a motor, the method may comprise monitoring state information of a main battery of the dual battery system and state information of a sub battery of the dual battery system, determining a demand power for the motor, selecting, based on the state information of the main battery, the state information of the sub battery, and the demand power, at least two amplification power candidate values for the sub battery, wherein the at least two amplification power candidate values represent potential discharge power levels that the sub battery is able to supply to the motor, and determining a discharge loss rate for each of the at least two amplification power candidate values, wherein the discharge loss rate corresponds to a measure of energy loss associated with the potential discharge power levels.

The method may further comprise selecting a minimum discharge loss rate from among respective discharge loss rates of the at least two amplification power candidate values.

The method may further comprise amplifying a discharge power of the sub battery based on one of the at least two amplification power candidate values, wherein the one corresponds to the minimum discharge loss rate.

The method may further comprise supplying the amplified discharge power of the sub battery to the motor to satisfy at least part of the demand power.

The method may further comprise determining, based on a difference between the amplified discharge power and the demand power, a power, wherein the power is used as a discharge power of the main battery or a charge power of the main battery.

The method, wherein the selecting the at least two amplification power candidate values for the sub battery may comprise determining, based on the state information of the main battery, whether the main battery is in a rechargeable state.

The method, wherein the selecting the at least two amplification power candidate values for the sub battery may further comprise based on the main battery being in the rechargeable state, setting the at least two amplification power candidate values, or based on the main battery being in a non-rechargeable state, adjusting an amplification rate such that an amplified discharge power of the sub battery is to be less than or equal to the demand power.

The method, wherein the determining the discharge loss rate for each of the amplification power candidate values may comprise determining whether each of the at least two amplification power candidate values is less than or equal to the demand power, and based on a determination that each of the at least two amplification power candidate values is less than or equal to the demand power, determining the discharge loss rate for each of the at least two amplification power candidate values based on a corresponding discharge power of the sub battery and an amplification efficiency value of an on-drive charge (ODC) circuit.

The method, wherein the determining the discharge loss rate for each of the at least two amplification power candidate values may comprise determining whether each of the at least two amplification power candidate values is less than or equal to the demand power, and based on a determination that each of the at least two amplification power candidate values is over the demand power, determining the discharge loss rate for each of the at least two amplification power candidate values based on a corresponding discharge power of the sub battery, an amplification efficiency value of an on-drive charge (ODC) circuit, the demand power, and a charge/discharge efficiency value of the main battery.

According to the present disclosure, a dual battery system may comprise a main battery configured to selectively supply power to a motor system configured to drive a motor, a sub battery configured to selectively supply power to the motor system, a battery management control circuit configured to detect information of the main battery and information of the sub battery to provide a control signal, a power control circuit configured to form, based on the control signal, a charge/discharge path of the main battery and a charge/discharge path of the sub battery, an on-drive charge (ODC) circuit configured to boost, based on the control signal, a discharge voltage of the sub battery, an inverter demand voltage supply circuit configured to provide the boosted discharge voltage to the motor system to satisfy at least part of a demand voltage for the motor, and an ODC efficiency control circuit configured to exchange data with the battery management control circuit and control the ODC circuit to increase boost efficiency of the ODC circuit.

The dual battery system, wherein the ODC efficiency control circuit is configured to monitor, via the battery management control circuit, state information of the main battery and state information of the sub battery, determine a demand power for the motor, select, based on the state information of the main battery, the state information of the sub battery, and the demand power, at least two amplification power candidate values for the sub battery, and determine a discharge loss rate for each of the at least two amplification power candidate values.

The dual battery system, wherein the ODC efficiency control circuit is configured to select a minimum discharge loss rate from among respective discharge loss rates of the at least two amplification power candidate values.

The dual battery system, wherein the ODC efficiency control circuit is configured to amplify a discharge power of the sub battery based on one of the at least two amplification power candidate values, wherein the one corresponds to the minimum discharge loss rate.

The dual battery system, wherein the inverter demand voltage supply circuit is configured to determine, based on a difference between the amplified discharge power and the demand power, a power, wherein the power is used as a discharge power of the main battery or a charge power of the main battery.

The dual battery system, wherein the ODC efficiency control circuit is configured to determine, based on the state information of the main battery, whether the main battery is in a rechargeable state.

The dual battery system, wherein the ODC efficiency control circuit is configured to, based on the main battery being in the rechargeable state, set the at least two amplification power candidate values.

The dual battery system, wherein the ODC efficiency control circuit is configured to, based on the main battery being in a non-rechargeable state, adjust an amplification rate such that an amplified power of the sub battery is to be less than or equal to the demand power.

The dual battery system, wherein the ODC efficiency control circuit is configured to determine whether each of the at least two amplification power candidate values is less than or equal to the demand power, and based on a determination that each of the at least two amplification power candidate values is less than or equal to the demand power, determine the discharge loss rate for each of the at least two amplification power candidate values based on a corresponding discharge power of the sub battery and an amplification efficiency value of the ODC circuit.

The dual battery system, wherein the ODC efficiency control circuit is configured to, based on a determination that each of the at least two amplification power candidate values is over the demand power, determine the discharge loss rate for each of the at least two amplification power candidate values based on a corresponding discharge power of the sub battery, an amplification efficiency value of the ODC circuit, the demand power, and a charge/discharge efficiency value of the main battery.

The dual battery system, wherein the ODC efficiency circuit is configured to adjust, based on driving conditions, an amplification efficiency value of the ODC circuit, wherein the driving conditions comprise at least one of a speed of the motor or a torque of the motor.

According to the present disclosure, a method performed by a dual battery system coupled to a first battery and to a second battery, the method may comprise determining, based on a state of the second battery and based on a demand power for a motor system, a discharge loss rate for each of at least two amplification power candidate values for the second battery, selecting, based on the discharge loss rates, an amplification power candidate value, of the at least two amplification power candidate values for the second battery, associated with a lowest discharge loss rate among the discharge loss rates, setting, based on the selected amplification power candidate value, a parameter associated with a discharge power of the second battery to supply power to the motor system, and controlling, based on the set parameter, power supply from the second battery to the motor system to satisfy at least part of the demand power.

### BRIEF DESCRIPTION OF THE DRAWINGS

FIG. 1 shows an example of an electrical system of an electric vehicle.

FIG. 2 and FIG. 3 show examples of an electrical system of an electric vehicle with a dual battery system.

FIG. 4, FIG. 5, and FIG. 6 show examples of an operating state of an inverter including an on-drive charge (ODC) module in the electric vehicle with the dual battery system shown in FIG. 3.

FIG. 7 show an example of a converter efficiency curve.

FIG. 8A and FIG. 8B show an example ODC efficiency map according to the magnitude of a discharge power.

FIG. 9 and FIG. 10 show examples of an operating state of an inverter including an ODC module in an electric vehicle to which a battery efficiency optimization method for a dual battery system according to an example of the present disclosure is applied.

FIG. 11 and FIG. 12 show an example of a battery efficiency optimization method for a dual battery system according to an example of the present disclosure.

FIG. 13 shows an example of mapping of a discharge power and a loss rate in a battery efficiency optimization method for a dual battery system according to an example of present disclosure.

### DETAILED DESCRIPTION OF THE DISCLOSURE

Hereinafter, examples of the present disclosure will be described in detail with reference to the accompanying drawings. The examples are not construed as limited to the disclosure and should be understood to include all changes, equivalents, and replacements within the idea and the technical scope of the disclosure.

The terms “module,” “unit,” and/or “-er/or” for referring to elements are assigned and used interchangeably in consideration of the ease of explanation, and thus the terms per se do not necessarily have different meanings or functions. The terms “module,” “unit,”and/or “-er/or”do not necessarily require physical separation.

Although terms including ordinal numbers, such as, “first,” “second,” and the like, may be used herein to describe various elements, the elements are not limited by these terms. These terms are only used to distinguish one element from another.

The term “and/or” is used to include any combination of multiple items that are subject to it. For example, “A and/or B” may include all three cases, for example, “A,” “B,” and “A and B.”

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, and C”, “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

When an element is described as “coupled” or “connected” to another element, the element may be directly coupled or connected to the other element. However, it is to be understood that another element may be present therebetween. In contrast, when an element is described as “directly coupled” or “directly connected” to another element, it is to be understood that there are no other elements therebetween.

The singular forms “a,” “an,” and “the” are intended to include the plural forms as well, unless the context clearly indicates otherwise. It is to be further understood that the terms “comprises/comprising” and/or “includes/including” used herein specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the present disclosure pertains. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

In addition, the term “unit,” “control unit,” “control device,” or “controller” is merely a widely used term for naming an element that controls a specific function, and does not mean a generic functional unit. For example, each controller may include circuit or circuitry (e.g., a communication device that communicates with another controller or a sensor to control a function assigned thereto), a memory that stores an operating system (OS), a logic command, input/output information, and the like, and one or more processors that perform determination, calculation, computation, decision, and the like that are necessary for controlling a function assigned thereto.

Meanwhile, a processor may include a semiconductor integrated circuit and/or electronic devices that perform at least one or more of comparison, determination, computation, and decision to achieve programmed functions. The processor may be, for example, any one or a combination of a computer, a microprocessor, a central processing unit (CPU), an application-specific integrated circuit (ASIC), an electronic circuitry, and a logic circuitry.

In addition, computer-readable recording media (or simply memory) include all types of storage devices that store data readable by a computer system. The storage devices may include at least one type of, for example, flash memory, hard disk, micro-type memory, card-type (e.g., secure digital (SD) card or extreme digital (XD) card) memory, random-access memory (RAM), static RAM (SRAM), read-only memory (ROM), programmable ROM (PROM), electrically erasable PROM (EEPROM), magnetic RAM (MRAM), magnetic disk, or optical disc.

This recording medium may be electrically connected to the processor, and the processor may load and record data from the recording medium. The recording medium and the processor may be integrated or may be physically separated.

Hereinafter, a battery efficiency optimization method for a dual battery system and a system therefor, according to examples of the present disclosure, will be described in detail with reference to the accompanying drawings.

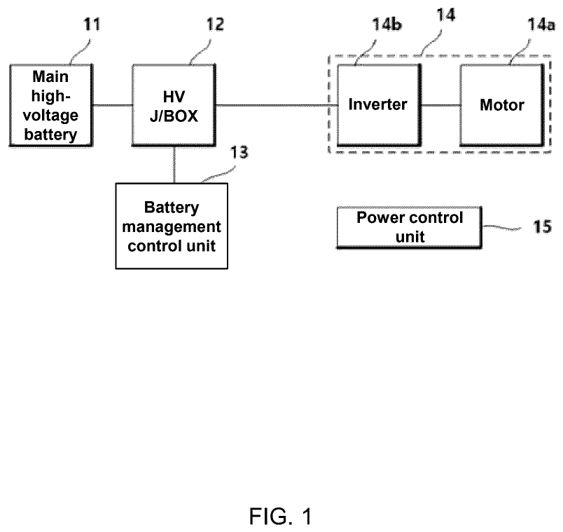

FIG. 1 shows an example of an electrical system of an electric vehicle (EV) or a plug-in hybrid electric vehicle (PHEV). The electrical system may include a motor system 14 comprising a motor 14a configured to generate a driving force and an inverter 14b configured to drive the motor 14a, a main high-voltage battery 11 used as a power source for the motor 14a, a high-voltage junction box (HV J/BOX) 12 configured to distribute and supply a high voltage supplied from the main high-voltage battery 11, and a battery management control unit 13 (e.g., management control circuit) configured to control a voltage distribution process of the HV J/BOX 12 and manage a state of the main high-voltage battery 11. A power control unit 15 (e.g., control circuit) is configured to perform overall control on the electrical system configured as described above.

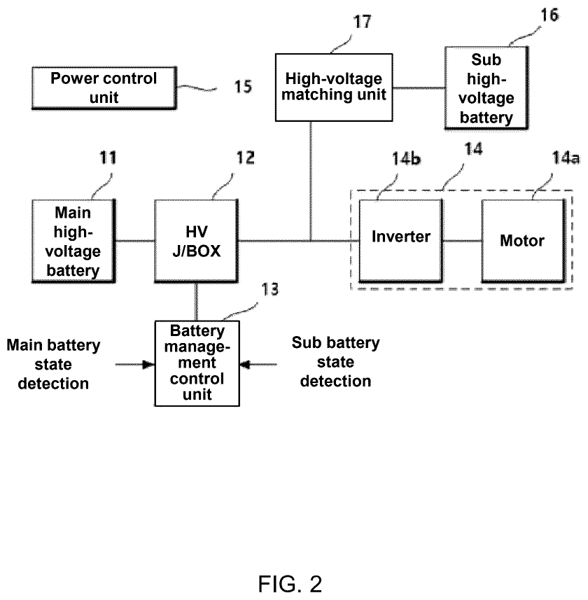

FIG. 2 shows an example of a dual battery system. The dual battery system comprises a main high-voltage battery 11 and a sub high-voltage battery 16.

The main high-voltage battery 11 and the sub high-voltage battery 16 may have differences in terms of capacity and capability (or performance). For example, the main high-voltage battery 11 has a capability of 123 kilowatt-hours (kWh) (697 volts) and the sub high-voltage battery 16 may have a capability of 30 kWh (174 volts), which is about 20% to 25% of the capability of the main high-voltage battery 11.

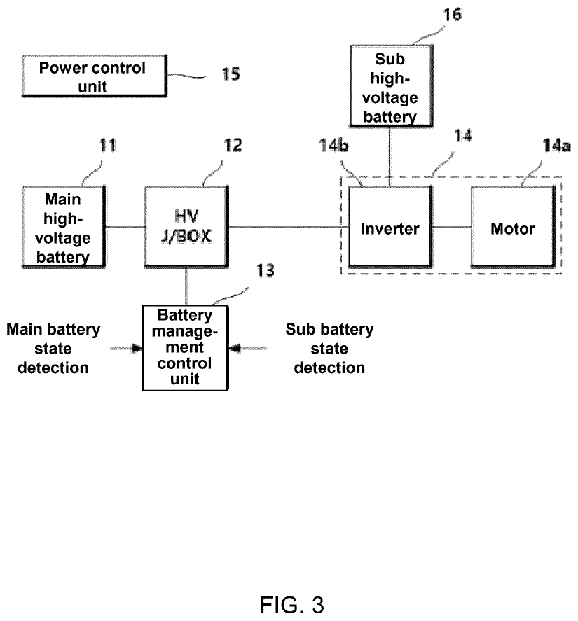

Based on the above exemplary configuration, a structure that uses a converter such as a high-voltage matching unit 17 (e.g., a high-voltage direct current to direct current (DC-DC) converter (HDC)) is provided as shown in FIG. 2 to match a voltage of the main high-voltage battery 11 and a voltage of the sub high-voltage battery 16. In addition, a structure using the functions of the inverter 14b without using the high-voltage matching unit 17 is provided as shown in FIG. 3.

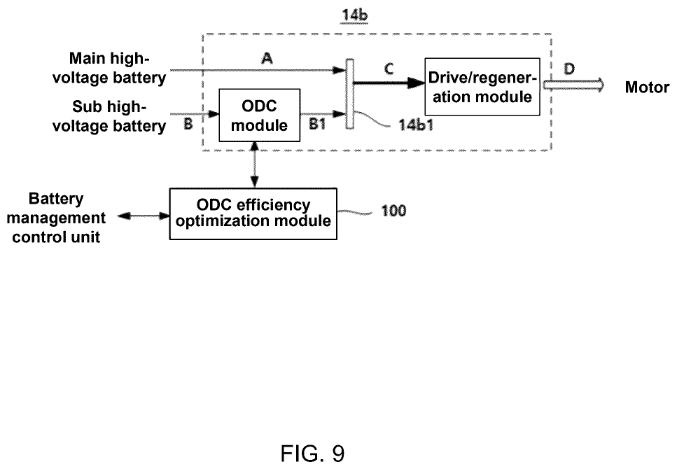

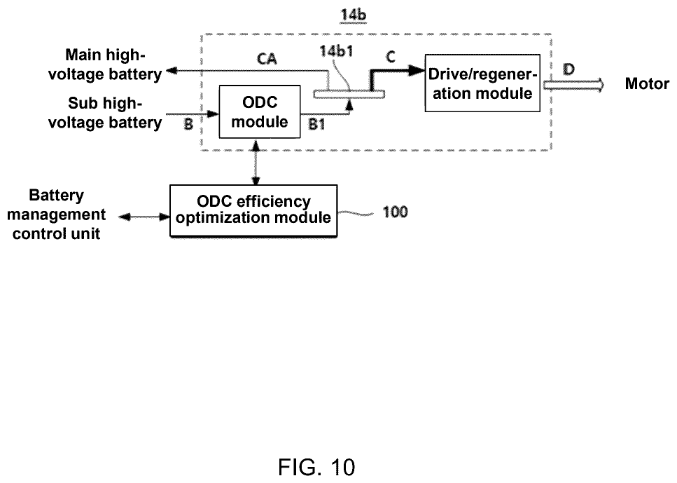

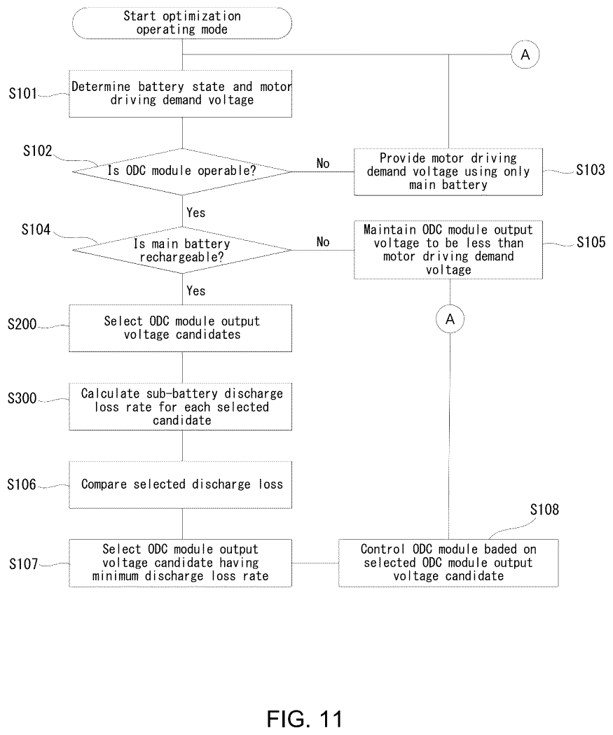

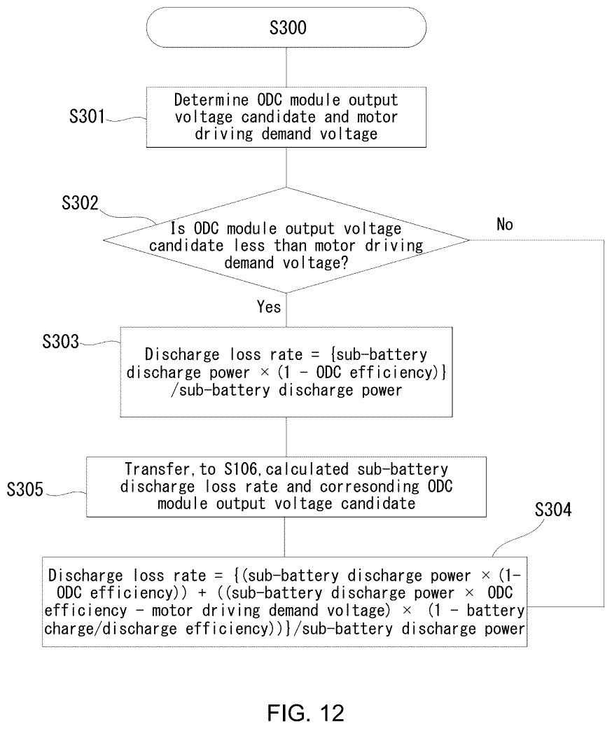

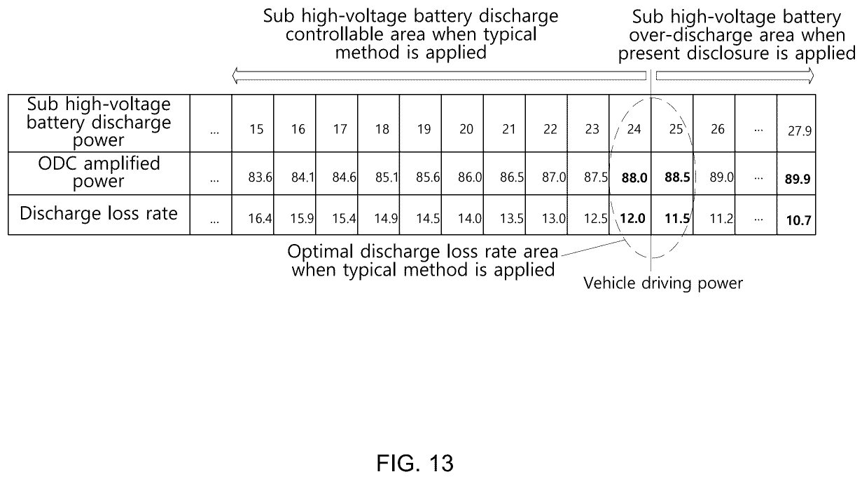

FIGS. 9 and 10 show examples of an operating state of an inverter including an on-drive charge (ODC) module in an electric vehicle to which a battery efficiency optimization method for a dual battery system according to an example of the present disclosure is applied. FIG. 11 and FIG. 12 show an example of a battery efficiency optimization method for a dual battery system according to an example of the present disclosure. FIG. 13 shows an example of mapping of a discharge power and a loss rate in a battery efficiency optimization method for a dual battery system according to an example of present disclosure.

Referring to FIG. 9, in an electric vehicle to which a battery efficiency optimization method for a dual battery system according to an example of the present disclosure is applied, a demand power D that is used to drive the vehicle during the operation of an inverter including an ODC module (no reference numeral given) may be shared by the main high-voltage battery 11 and the sub high-voltage battery 16. In a case where the vehicle demand power D is greater than or equal to an output power B1 of the ODC module, a discharge power B of the sub high-voltage battery 16 may be improved through an amplification efficiency by ODC control of the ODC module and be converted into the ODC output power B1. In this case, a demand energy used excluding the ODC output power B1 from the vehicle demand power D may be transferred from the main high-voltage battery 11 (indicated as “A”) to drive the vehicle.

In contrast, in a case where the vehicle demand power D is less than the ODC output power B1, the discharge power B of the sub high-voltage battery 16 may be improved through an efficiency by the ODC control and be converted into the ODC output power B1, as shown in FIG. 10. In this case, a portion of the ODC output power B1 that is left after responding to the vehicle demand power D may be used to charge the main high-voltage battery 11 (indicated as “CA”).

In FIG. 9 and FIG. 10, a reference numeral 14b1 that has not been described above refers to an inverter demand voltage supply module.

In addition, in FIG. 9 and FIG. 10, a reference numeral 100 that has not been described above refers to an ODC efficiency optimization module configured to control the ODC module to optimize a step-up efficiency of the ODC module while exchanging data with the battery management control unit 13.

It is to be noted that the ODC efficiency optimization module may be implemented with a memory configured to store a program for performing the functions and a processor configured to execute the program, and memories of the respective modules may be integrated into one or more memories, and processors thereof may be integrated into one or more processors.

Further, the ODC module described herein may be a separate circuit for stepping up a voltage, which is provided in the inverter 14b, or may be a function of changing an internal coupling relationship in the inverter 14b, but may not be limited to a configuration described herein that performs a function of stepping up a discharge voltage of a sub high-voltage battery introduced according to a control signal and outputting the voltage.

The operations of a battery efficiency optimization system in a dual battery system including an ODC efficiency optimization module 100 are described below with reference to FIG. 11, FIG. 12, and FIG. 13. It is to be noted that, in FIG. 11 and FIG. 12, “sub-battery” is an abbreviation for a sub high-voltage battery and “main battery” is an abbreviation for a main-high voltage battery.

FIG. 11 shows an example of a battery efficiency optimization method for a dual battery system. In step S101, the ODC efficiency optimization module 100 may determine a state of the main high-voltage battery 11 and a state of the sub high-voltage battery 16 and a demand power used to drive the motor 14a. In this case, a method of determining the demand power for driving the motor 14a may be determined by “rpm x motor torque.”

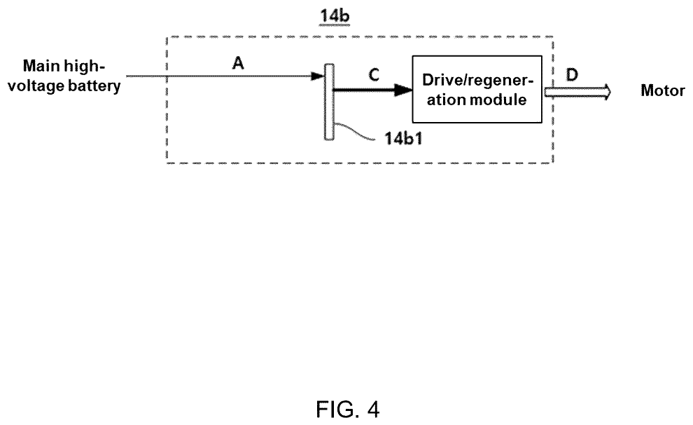

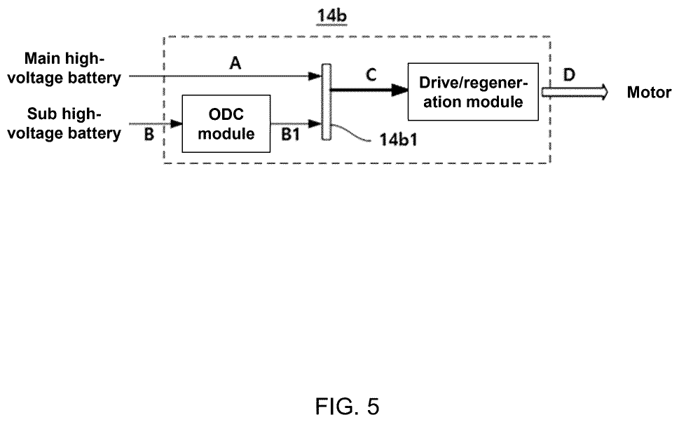

In step S102, it may determine whether the ODC module is operable, and if it is determined in step S102 that the ODC module is not operable, perform step S103. In step S103, the demand power for driving the motor 14a may be supplied using only the main high-voltage battery 11, as shown in FIG. 4.

In contrast, if it is determined in step S102 that the ODC module is operable, it may perform step S104 to determine whether the main high-voltage battery 11 is rechargeable. In this case, if it is determined that the main high-voltage battery 11 is not rechargeable, i.e., the main high-voltage battery 11 is fully charged, it may perform step S105 to maintain an output voltage of the ODC module to be less than a demand voltage used to drive the motor 14a according to the control method shown in FIG. 5 or FIG. 6.

Therefore, the process of step S103 or step S105 described above may be to control the operations of the ODC module according to the control method, and in practice, the control method according to an example of the present disclosure may be limited to a case where step S200 is performed.

That is, if it is determined in step S102 that the ODC module is operable, and if it is determined in step S103 that the main high-voltage battery 11 is rechargeable, the ODC efficiency optimization module 100 may perform step S200.

In step S200, based on the state information of the monitored batteries and the demand power, it may select at least two candidates (in the case shown in FIG. 13, at least 15 areas including a total of 11 lower areas including 10 classified areas and a minimum reference area, and a plurality of upper areas) for an amplified power B1 of the sub high-voltage battery 16.

In step S300, if the at least two candidates for the amplified power B1 of the sub high-voltage battery 16 are determined in step S200, the ODC efficiency optimization module 100 may determine a discharge loss rate for each of the selected candidates (also “amplification power candidates”or “amplification power candidate values”herein).

The amplification power candidate values may refer to potential power levels that the sub high-voltage battery is able to supply after its discharge power is amplified by the ODC (On-Drive Charge) circuit. These candidate values are determined based on the state information of the main and sub batteries (e.g., charge levels and capacities) and the motor's demand power, which is calculated using parameters such as speed (RPM) and torque. The amplification power candidate values may represent discrete options for amplified power levels, allowing the ODC efficiency circuit to evaluate and compare discharge loss rates for each candidate. This comparison may help the system select the most efficient candidate value, minimizing energy losses and increasing overall system performance. These candidate values may be mapped across operational ranges, as shown in FIG. 13 to facilitate efficiency increase or optimization under various driving conditions.

Subsequently, the ODC efficiency optimization module 100 may compare at least two discharge loss rates determined in step S300 in step S106, and select a discharge loss rate having a minimum value in step S107.

The discharge loss rate may be a measure of energy inefficiency associated with the discharge of the sub high-voltage battery during operation. It may quantify the proportion of energy lost during the process of converting the sub-battery's discharge power into amplified output power through the ODC (On-Drive Charge) circuit. The discharge loss rate may be determined based on factors such as an amplification efficiency of the ODC circuit, a difference between an amplified power and the motor's demand power, and the charging/discharging efficiencies of the main battery. By determining and comparing discharge loss rates for various amplification power candidate values, the system may select the power level that minimizes energy loss, thereby enhancing overall system efficiency.

Subsequently, in step S108, the ODC efficiency optimization module 100 may perform an amplification on a discharge power of the sub high-voltage battery 16 based on an amplification power candidate corresponding to the discharge loss rate selected in step S107.

The output voltage B1 of the ODC module, which is amplified with the discharge power B of the sub high-voltage battery 16 by the amplification process (i.e., step S108) as shown in FIG. 9 or 10, may be supplied to the inverter demand voltage supply module 14b1, and the inverter demand voltage supply module 14b1 may then compare the power (indicated as “B1”) and the demand power (indicated as “D”). In this case, if the amplified power B1 is less than the demand power D, the inverter demand voltage supply module 14b1 may provide an output voltage (indicated as “C”) acquired by adding a power corresponding to the magnitude of such a difference to a discharge voltage A of the main high-voltage battery 11 as shown in FIG. 9 to a drive/regeneration module (no reference numeral given).

The drive/regeneration module may be configured to supply a drive voltage to the motor 14a or transfer a regenerative voltage generated from the motor 14a by regenerative braking to the battery side.

Further, the amplified power B1 of the discharge power B of the sub high-voltage battery 16 may be supplied to the inverter demand voltage supply module 14b1, and the inverter demand voltage supply module 14b1 may compare the power (indicated as “B1”) and the demand power (indicated as “D”). In this case, if the amplified power B1 is greater than the demand power D, the inverter demand voltage supply module 14b1 may provide a power corresponding to the magnitude of such a difference as a charging voltage CA of the main high-voltage battery 11 as shown in FIG. 10.

Referring briefly to FIG. 13, in an example shown in FIG. 13 assuming that the ODC efficiency is linear between a minimum power and a maximum power, the system efficiency may be highest at the maximum power, but if it is non-linear according to an efficiency map, an optimal system efficiency point may change.

Further, as an example for a vehicle drive operation point 1 (30 Nm, 7000 rpm), it is exemplified on the premise that the sub high-voltage battery 16 maintains the same level as the driving power of the vehicle at a discharge of 24 kilowatts (kW) to 25 kW, reflecting the ODC efficiency.

Therefore, in step S200 described above, the amplification power candidates for the sub high-voltage battery 16 according to the ODC discharge efficiency may be set for at least 15 areas divided by the sub-battery discharge power as shown in FIG. 13.

For example, if a plurality of amplification power candidates is set in step S200, the process of step S300 may determine a discharge loss rate for each amplification power candidate through the process as shown in FIG. 12.

That is, in step S301, an output voltage candidate value of the ODC module and a demand voltage (or requested voltage) for driving a motor may be determined, and in step S302, whether the amplified power of the sub high-voltage battery 16 is less than or equal to the demand power may be determined.

In this case, if it is determined in step S302 that it is less than or equal to the demand power, step S303 may be performed to determine the discharge loss rate using “{discharge power of sub high-voltage battery×(1−amplification efficiency)}/discharge power of sub high-voltage battery.”

In contrast, if it is determined in step S302 that the amplified power of the sub high-voltage battery is not less than the demand power, step S304 may be performed to determine the discharge loss rate using “{(discharge power of sub high-voltage battery×(1−amplification efficiency))+((discharge power of sub high-voltage battery×amplification efficiency−demand voltage)×(1−charge/discharge efficiency of main high-voltage battery))}/sub-battery discharge power.”The amplification efficiency may refer to a ratio between the discharge power of the sub high-voltage battery and the ODC amplification power, in the example shown in FIG. 13. In addition, the charge and discharge efficiency of the main high-voltage battery 11 is generally based on historical data of the charge and discharge of the main high-voltage battery 11, but it is assumed that the charge and discharge efficiency of the main high-voltage battery 11 is provided by the battery management control unit 13 according to an example of the present disclosure.

In step S305, if the discharge loss rate is determined in step S303 or step S304, the determined discharge loss rate and an output voltage candidate value of the ODC module that is a source for determining the discharge loss rate may be integrated into a single data pair, and the single data pair may be transferred to step S106.

The inverter 14b may be able to step up the power of a battery due to its structural characteristics, and a control method of stepping up a voltage of the sub high-voltage battery 16 during driving, using the inverter 14b, to provide energy used for the driving or charge the main high-voltage battery 11 is referred to as “on-drive charge (ODC).”

Such an ODC control method may be described with reference to FIG. 4, FIG. 5, and FIG. 6. Referring to FIG. 4, the main high-voltage battery 11 may provide all the demand power used to drive a vehicle without the ODC control (as shown in FIG. 4).

In addition, referring to FIG. 5, both the main high-voltage battery 11 and the sub high-voltage battery 16 may share the demand power used to drive the vehicle, and if a vehicle demand power D is greater than or equal to an output power B1 of an ODC module (no reference numeral given), a discharge power B of the sub high-voltage battery 16 may be improved through an amplification efficiency by the ODC control of the ODC module and be converted into the ODC output power B1. In this case, the demand energy used excluding the ODC output power B1 from the vehicle demand power D may be transferred from the main high-voltage battery 11 (indicated as “A”) to drive the vehicle.

In contrast, referring to FIG. 6, if the vehicle demand power D is less than the ODC output power B1, the discharge power B of the sub high-voltage battery 16 may be improved through an efficiency by the ODC control and be converted into the ODC output power B1. In this case, a portion of the ODC output power B1 that is left after responding to the vehicle demand power D may be used to charge the main high-voltage battery 11 (indicated as “CA”).

In FIGS. 4 through 6, a reference numeral 14b1 that has not been described above refers to an inverter demand voltage supply module.

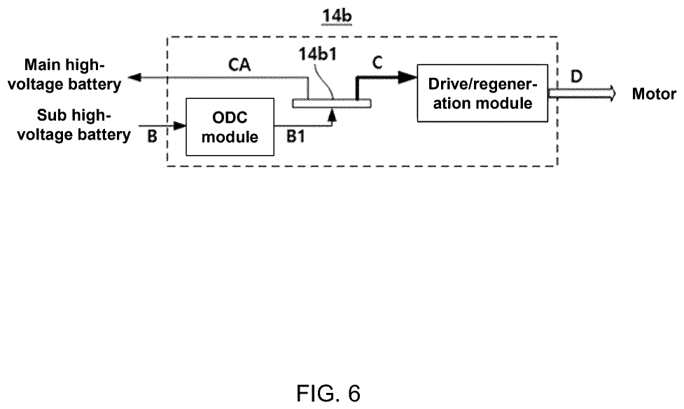

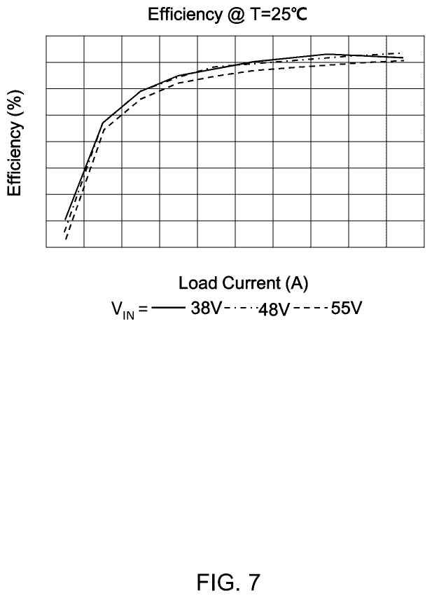

Referring to a converter efficiency curve shown in FIG. 7, it may be verified that, in general, a converter tends to converge to higher efficiency as power increases.

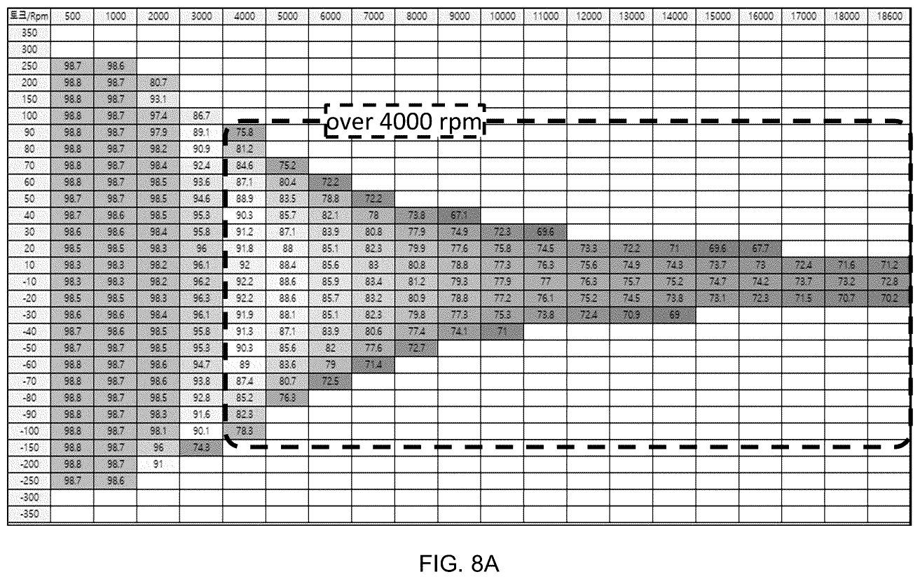

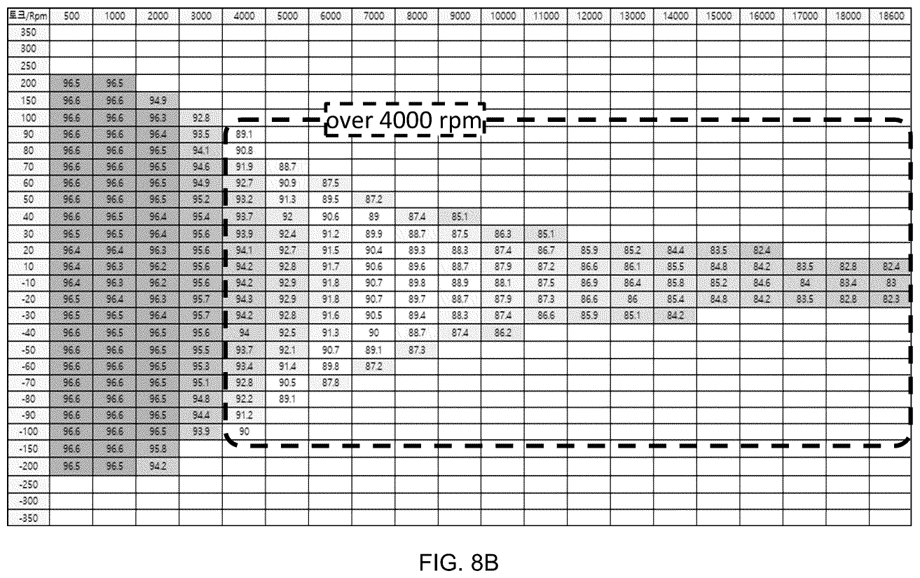

Similarly, referring to FIG. 8A and FIG. 8B, which respectively show an example efficiency map of an output power of 10 kW of the ODC module and an example efficiency map of an output power of 28 kW of the ODC module, it can be verified that the efficiency is increased as the discharge power increases at the rpms over 4000, the increase rate of the efficiency being 12.7%. However, despite the efficiency increase, the ODC control method is to control the vehicle demand power D to be greater than or equal to the ODC output power B1 in all driving situations.

However, there is an area where efficiency is better if the vehicle demand power is less than the ODC output power during actual driving on a road, and there is a use for power control technology corresponding to such an area to improve system efficiency.

An object of examples of the present disclosure is to solve the challenges described above.

One example of the present disclosure is to provide a battery efficiency optimization method in a dual battery system and a system therefor, which may determine an ODC discharge power based on a discharge loss rate calculation by comparing an available ODC discharge power in an ODC-equipped dual battery system and a d vehicle riving power, thereby enabling system optimization through efficiency comparison in the entire area under the ODC control and improving a power ratio compared to an existing one during ODC driving in a high-speed driving area on a real road.

According to at least one example of the present disclosure, there is provided a battery efficiency optimization method for a dual battery system including a motor system configured to drive a motor, a main battery, and a sub battery, the main battery and the sub battery configured to selectively supply power to the motor system. The battery efficiency optimization method may include monitoring state information of the main battery and the sub battery, determining a demand power for the motor; selecting at least two amplification power candidates for the sub battery based on the state information and the demand power; and determining a discharge loss rate for each of the amplification power candidates.

The battery efficiency optimization method may further include selecting a minimum discharge loss rate from among respective discharge loss rates of the amplification power candidates.

The battery efficiency optimization method may further include performing an amplification on a discharge power of the sub battery based on the amplification power candidate corresponding to the minimum discharge loss rate.

The battery efficiency optimization method may further include supplying an amplified power of the sub battery as the demand power to the motor system.

The battery efficiency optimization method may further include using a power determined based on a difference between the amplified power and the demand power as a discharge power or a charge power of the main battery.

The selecting the at least two amplification power candidates for the sub battery may include determining, based on the state information of the main battery, whether the main battery is in a rechargeable state.

The selecting the at least two amplification power candidates for the sub battery further may include: in response to the main battery being in the rechargeable state, setting the at least two amplification power candidates; or in response to the main battery being in a non-rechargeable state, adjusting an amplification rate such that an amplified power of the sub battery is to be less than or equal to the demand power.

The determining the discharge loss rate for each of the amplification power candidates may include: determining whether each of the amplification power candidates is less than or equal to the demand power; and in response to a determination that each of the amplification power candidates is less than or equal to the demand power, determining the discharge loss rate for each of the amplification power candidates based on a corresponding discharge power of the sub battery and an amplification efficiency of an on-drive charge (ODC) module.

The determining of the discharge loss rate for each of the amplification power candidates may include: determining whether each of the amplification power candidates is less than or equal to the demand power; and in response to a determination that each of the amplification power candidates is over the demand power, determining the discharge loss rate for each of the amplification power candidates based on a corresponding discharge power of the sub battery, the amplification efficiency of an on-drive charge (ODC) module, the demand power, and a charge/discharge efficiency of the main battery.

According to at least one example of the present disclosure, there is provided a dual battery efficiency optimization system, including: a motor system configured to drive a motor; a main battery configured to selectively supply power to the motor system; a sub battery configured to selectively supply power to the motor system; a power control unit configured to form a charge/discharge path of the main battery and the sub battery in response to a control signal; a battery management control unit configured to acquire information of the main battery and the sub battery to provide the control signal to the power control unit; an on-drive charge (ODC) module configured to boost a discharge voltage of the sub battery according to a control signal; an inverter demand voltage supply module configured to provide the boosted voltage of the ODC module as a demand voltage for the motor; and an ODC efficiency optimization module configured to exchange data with the battery management control unit and control the ODC module to optimize a boost efficiency of the ODC module.

The ODC efficiency optimization module may be configured to: monitor state information of the main battery and the sub battery via the battery management control unit, determine a demand power for the motor, select at least two amplification power candidates for the sub battery based on the state information and the demand power, and determine a discharge loss rate for each of the amplification power candidates.

The ODC efficiency optimization module may be configured to select a minimum discharge loss rate from among respective discharge loss rates of the amplification power candidates.

The ODC efficiency optimization module may be configured to perform an amplification on a discharge power of the sub battery based on the amplification power candidate corresponding to the minimum discharge loss rate.

The inverter demand voltage supply module may be configured to use a power determined based on a difference between the discharge power amplified by the ODC module and the demand power as a discharge power and/or a charge power of the main battery.

The ODC efficiency optimization module may be configured to determine, based on the state information of the main battery, whether the main high-voltage battery is in a rechargeable state.

The ODC efficiency optimization module may be configured to, in response to the main battery being in the rechargeable state, set the at least two amplification power candidates.

The ODC efficiency optimization module may be configured to, in response to the main battery being in a non-rechargeable state, adjust an amplification rate such that an amplified power of the sub battery is to be less than or equal to the demand power.

The ODC efficiency optimization module may be configured to: determine whether each of the amplification power candidates is less than or equal to the demand power, and in response to a determination that each of the amplification power candidates is less than or equal to the demand power, determine the discharge loss rate for each of the amplification power candidates based on a corresponding discharge power of the sub battery and an amplification efficiency of the ODC module.

The ODC efficiency optimization module may be configured to, in response to a determination that each of the amplification power candidates is over the demand power, determine the discharge loss rate for each of the amplification power candidates based on a corresponding discharge power of the sub battery, the amplification efficiency of the ODC module, the demand power, and a charge/discharge efficiency of the main battery.

At least one example of the present disclosure provides a battery efficiency optimization method in a dual battery system and a system therefor, which may determine an ODC discharge power by comparing an available ODC discharge power in an ODC-equipped dual battery system and a vehicle driving power and determining a discharge loss rate, thereby enabling system optimization based on efficiency comparison in the entire area under the ODC control and improving a power ratio compared to an existing one during ODC driving in a high-speed driving area on a real road.

The process described above may allow the system including the ODC module to set a discharge loss rate for optimizing the discharge efficiency (main/auxiliary battery) and control the ODC module to have a minimum discharge loss rate by determining such a loss rate for all situations.

Therefore, according to one example, in an ODC-equipped dual battery system, comparing an available ODC discharge power and a vehicle driving power and determining an ODC discharge power based on a determined discharge loss rate may optimize the system through efficiency comparison in all areas under the ODC control and improve the power ratio compared to an existing one during ODC driving in a high-speed driving area on a real road.

While preferred examples of the present disclosure have been shown and described above, the present disclosure is not limited to the specific examples described above, various changes and modifications may be made by one of ordinary skill in the art to which the present disclosure pertains without departing from the spirit and scope of the disclosure, and such changes and modifications should not be construed as being independent of the technical ideas or views of the present disclosure.

1. A method performed by a dual battery system for supplying power to a motor, the method comprising:
monitoring state information of a main battery of the dual battery system and state information of a sub battery of the dual battery system;
determining a demand power for the motor;
selecting, based on the state information of the main battery, the state information of the sub battery, and the demand power, at least two power candidate values for the sub battery; and
determining a discharge loss rate for each of the at least two power candidate values.

2. The method of claim 1, further comprising:
selecting a minimum discharge loss rate from among respective discharge loss rates of the at least two power candidate values.

3. The method of claim 2, further comprising:
boosting a discharge voltage of the sub battery based on one of the at least two power candidate values, wherein the one corresponds to the minimum discharge loss rate.

4. The method of claim 3, further comprising:
supplying a power of the boosted discharge voltage of the sub battery to the motor to satisfy at least part of the demand power.

5. The method of claim 4, further comprising:
determining, based on a difference between the power of the boosted discharge voltage and the demand power, a power, wherein the power is used as a discharge power of the main battery or a charge power of the main battery.

6. The method of claim 1, wherein the selecting the at least two power candidate values for the sub battery comprises:
determining, based on the state information of the main battery, whether the main battery is in a rechargeable state.

7. The method of claim 6, wherein the selecting the at least two power candidate values for the sub battery further comprises:
based on the main battery being in the rechargeable state, setting the at least two power candidate values; or
based on the main battery being in a non-rechargeable state, adjusting an amplification rate of an on-drive charge (ODC) circuit such that power of a boosted voltage of the sub battery is to be less than or equal to the demand power.

8. The method of claim 7, wherein the determining the discharge loss rate for each of the power candidate values comprises:
determining whether each of the at least two power candidate values is less than or equal to the demand power; and
based on a determination that each of the at least two power candidate values is less than or equal to the demand power, determining the discharge loss rate for each of the at least two power candidate values based on an efficiency value of the on-drive charge (ODC) circuit.

9. The method of claim 1, wherein the determining the discharge loss rate for each of the at least two power candidate values comprises:
determining whether each of the at least two power candidate values is less than or equal to the demand power; and
based on a determination that each of the at least two power candidate values is over the demand power, determining the discharge loss rate for each of the at least two power candidate values based on a corresponding discharge power of the sub battery, an efficiency value of an on-drive charge (ODC) circuit, the demand power, and a charge/discharge efficiency value of the main battery.

10. A dual battery system comprising:
a main battery configured to selectively supply power to a motor system configured to drive a motor;
a sub battery configured to selectively supply power to the motor system;
a battery management control circuit configured to detect information of the main battery and information of the sub battery to provide a control signal;
a power control circuit configured to form, based on the control signal, a charge/discharge path of the main battery and a charge/discharge path of the sub battery;
an on-drive charge (ODC) circuit configured to boost, based on the control signal, a discharge voltage of the sub battery;
an inverter demand voltage supply circuit configured to provide a power of the boosted discharge voltage to the motor system to satisfy at least part of a demand power for the motor; and
an ODC efficiency control circuit configured to exchange data with the battery management control circuit and control the ODC circuit to increase boost efficiency of the ODC circuit.

11. The dual battery system of claim 10, wherein the ODC efficiency control circuit is configured to:
monitor, via the battery management control circuit, state information of the main battery and state information of the sub battery,
determine a demand power for the motor,
select, based on the state information of the main battery, the state information of the sub battery, and the demand power, at least two power candidate values for the sub battery, and
determine a discharge loss rate for each of the at least two power candidate values.

12. The dual battery system of claim 11, wherein the ODC efficiency control circuit is configured to:
select a minimum discharge loss rate from among respective discharge loss rates of the at least two power candidate values.

13. The dual battery system of claim 12, wherein the ODC efficiency control circuit is configured to:
boost a discharge voltage of the sub battery based on one of the at least two power candidate values, wherein the one corresponds to the minimum discharge loss rate.

14. The dual battery system of claim 13, wherein the inverter demand voltage supply circuit is configured to:
determine, based on a difference between a power of the boosted discharge voltage of the sub battery and the demand power, a power, wherein the power is used as a discharge power of the main battery or a charge power of the main battery.

15. The dual battery system of claim 11, wherein the ODC efficiency control circuit is configured to:
determine, based on the state information of the main battery, whether the main battery is in a rechargeable state.

16. The dual battery system of claim 15, wherein the ODC efficiency control circuit is configured to:
based on the main battery being in the rechargeable state, set the at least two power candidate values.

17. The dual battery system of claim 15, wherein the ODC efficiency control circuit is configured to:
based on the main battery being in a non-rechargeable state, adjust an amplification rate of the ODC circuit such that a power of a boosted discharge voltage of the sub battery is to be less than or equal to the demand power.

18. The dual battery system of claim 16, wherein the ODC efficiency control circuit is configured to:
determine whether each of the at least two power candidate values is less than or equal to the demand power, and
based on a determination that each of the at least two power candidate values is less than or equal to the demand power, determine the discharge loss rate for each of the at least two power candidate values based on an efficiency value of the ODC circuit.

19. The dual battery system of claim 11, wherein the ODC efficiency control circuit is configured to:
based on a determination that each of the at least two power candidate values is over the demand power, determine the discharge loss rate for each of the at least two power candidate values based on a corresponding discharge power of the sub battery, an efficiency value of the ODC circuit, the demand power, and a charge/discharge efficiency value of the main battery.

20. A method performed by a dual battery system coupled to a first battery and to a second battery, the method comprising:
determining, based on a state of the second battery and based on a demand power for a motor system, a discharge loss rate for each of at least two power candidate values for the second battery;
selecting, based on the discharge loss rates, an power candidate value, of the at least two power candidate values for the second battery, associated with a lowest discharge loss rate among the discharge loss rates;
setting, based on the selected power candidate value, a parameter associated with a discharge power of the second battery to supply power to the motor system; and
controlling, based on the set parameter, power supply from the second battery to the motor system to satisfy at least part of the demand power.
